(19) United States
(12) Patent Application Publication
(10) Pub. No.: US 2012/0236332 A1
(43) Pub. Date: Sep. 20, 2012

(54) INFORMATION PROCESSING APPARATUS, INFORMATION PROCESSING METHOD, AND RECORDING MEDIUM FOR STORING PROGRAMS

(75) Inventor: Shinya Yamazaki, Yokohama-shi (JP)

(73) Assignee: CANON KABUSHIKI KAISHA, Tokyo (JP)

(21) Appl. No.: 13/407,598

(22) Filed: Feb. 28, 2012

(30) Foreign Application Priority Data
Mar. 14, 2011 (JP) 2011-055222

(51) Int. Cl. G06F 15/00

(52) U.S. Cl. 358/1.9

(57) ABSTRACT

A predetermined quantity of parameter values, that are varied in stages, are generated on the basis of the value of a reference parameter input by a user. A print job is generated that includes a drawing command for printing a reduced image of image data, and this drawing command is converted into raster data and stored. A predetermined quantity of the stored raster data is copied, and the stored raster data is subjected to image adjustment processing on the basis of the reference parameter. The copied raster data is also subjected to image adjustment processing on the basis of the generated parameter values.

### BACKGROUND OF THE INVENTION

1. Field of the Invention

The present invention relates to an information processing apparatus for processing print data, an information processing method, and a recording medium for storing programs.

2. Description of the Related Art

For a user to adjust the color, density, and contrast of a printed image as desired, parameters corresponding to these values (image adjustment parameters) have to be suitably set. However, it is difficult for a user to set a number of image adjustment parameters all at once to adjust a printed image to the desired color, density, and contrast. In Japanese Patent No. 4,408,858 is disclosed a method for suitably setting a plurality of image adjustment parameters, in which it is stated that image adjustment parameters are set in a plurality of stages, and an original image is subjected to image processing according to the combination of image adjustment parameters at each stage. Also disclosed is a printing method (pattern printing) in which a plurality of images with different combinations of these image adjustment parameters are printed side by side on a single page. According to Japanese Patent No. 4,408,858, the user looks at images (index images) of pattern printing and selects the index image having the desired color, density, and contrast.

In pattern printing, a plurality of original images that have undergone different kinds of image processing are arranged on a single printed page. Therefore, processing in which the original image is copied is necessary in the course of the pattern printing processing. The format of the print data input to the printer driver is generally one such as PDL (page description language), which is made up of a plurality of drawing commands. FIG. 10 is a simplified view of the processing involved when a printer driver performs pattern printing. An original image 101 sent from an application 201 is stored as a print job 214 in a print queue 213. At this point, the print job 214 is made up of data in PDL format, and includes a drawing command group that expresses the drawing content of the original image 101. Here, when a printer driver 220 copies the original image 101 in order to perform pattern printing, this drawing command group has to be copied in a number equal to the number of images to be arranged. However, it generally takes time to convert (rasterize) PDL into a raster image and produce print image data 103, and the more drawing commands there are, the longer this takes. Therefore, when the printer driver performs pattern printing, rasterization takes longer than in normal printing, so the printing ends up taking longer. This problem is particularly serious when there are a large number of index images, or when the original image 101 is complicated and there are a large number of drawing commands. In other words, in the past, when a printer driver executed pattern printing, the processing took much longer than in normal printing.

### SUMMARY OF THE INVENTION

An aspect of the present invention is to eliminate the above-mentioned problems with the conventional technology. The present invention provides an information processing apparatus, an information processing method, and a recording medium that stores programs, with which the processing time in pattern printing is reduced.

The present invention in its first aspect provides an information processing apparatus, comprising: an acquisition unit configured to acquire image data; an accept unit configured to accept a reference parameter that sets a reference image quality; a parameter generation unit configured to generate a predetermined quantity of parameter values that are varied in stages, on the basis of the reference parameter; a job generation unit configured to generate a print job including a drawing command for printing a reduced image of the image data; a conversion unit configured to convert the drawing command included in the print job into raster data; a storage unit configured to store the raster data converted by the conversion unit; a copying unit configured to copy a predetermined quantity of the raster data stored by the storage unit; a first processing unit configured to subject the raster data copied by the copying unit to image adjustment processing on the basis of the reference parameter; and a second processing unit configured to subject the raster data copied by the copying unit to the image adjustment processing on the basis of the parameter values generated by the parameter generation unit.

The present invention in its second aspect provides an information processing method executed by an information processing apparatus, comprising: an acquisition step of acquiring image data; an accept step of accepting a reference parameter that sets a reference image quality; a parameter generation step of generating a predetermined quantity of parameter values that are varied in stages, on the basis of the reference parameter; a job generation step of generating a print job including a drawing command for printing a reduced image of the image data; a conversion step of converting the drawing command included in the print job into raster data; a storage step of storing the raster data converted by the conversion step; a copying step of copying a predetermined quantity of the raster data stored by the storage step; a first processing step of subjecting the raster data copied by the copying step to image adjustment processing on the basis of the reference parameter; and a second processing step of subjecting the raster data copied by the copying step to the image adjustment processing on the basis of the parameter values generated by the parameter generation step.

The present invention in its third aspect provides a recording medium that can be read by a computer and that stores a program that causes the computer to execute the steps of: an acquisition step of acquiring image data; an accept step of accepting a reference parameter that sets a reference image quality; a parameter generation step of generating a predetermined quantity of parameter values that are varied in stages, on the basis of the reference parameter; a job generation step of generating a print job including a drawing command for printing a reduced image of the image data; a conversion step of converting the drawing command included in the print job into raster data; a storage step of storing the raster data converted by the conversion step; a copying step of copying a predetermined quantity of the raster data stored by the storage step; a first processing step of subjecting the raster data copied by the copying step to image adjustment processing on the basis of the reference parameter; and a second processing step of subjecting the raster data copied by the copying step to the image adjustment processing on the basis of the parameter values generated by the parameter generation step.

The processing time in pattern printing can be reduced with the present invention.

Further features of the present invention will become apparent from the following description of exemplary embodiments with reference to the attached drawings.

### BRIEF DESCRIPTION OF THE DRAWINGS

FIG. 1 is a block diagram of the hardware configuration of a printing system;

FIG. 2 is a diagram illustrating an example of the functional configuration of an information processing apparatus;

FIG. 3 is a diagram illustrating an example of a user interface;

FIGS. 4A and 4B are diagrams illustrating examples of the layout of index images;

FIG. 5 is a diagram illustrating the configuration of a print job;

FIG. 6 is a flowchart of the processing performed by a layout filter in pattern printing;

FIG. 7 is a flowchart of the processing performed by a rendering filter in pattern printing;

FIG. 8 is a flowchart of the image processing performed by a rendering filter in pattern printing;

FIG. 9 is a flowchart of the processing performed by a rendering filter 223 in embodiment 2;

FIG. 10 is a diagram illustrating the processing generally performed by a printer driver; and

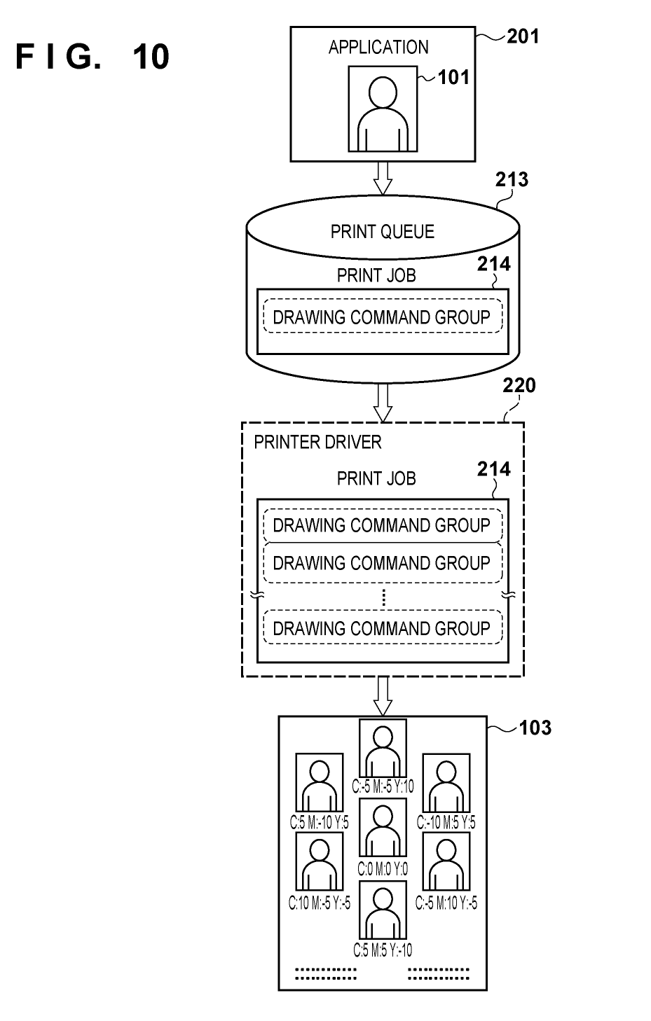

FIG. 11 is a diagram illustrating the flow of specific processing in a rendering filter.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Those constituent elements that are the same will be numbered the same and not described again.

### Embodiment 1

### Hardware Configuration

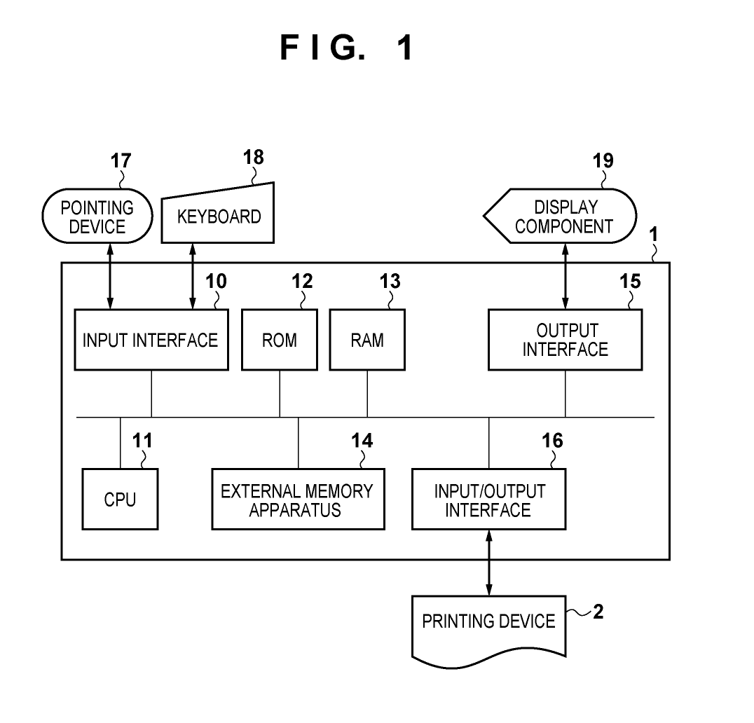

FIG. 1 is a block diagram of the hardware configuration of a printing system. In this drawing, a PC 1 is an example of an information processing apparatus, which has an input interface 10, a CPU 11, a ROM 12, a RAM 13, an external memory apparatus 14, an output interface 15, and an input/output interface 16. The input interface 10 is connected to a keyboard 18, a pointing device 17, and other such input devices, and the output interface 15 is connected to a display component 19 or another such display device. The ROM 12 stores an initialization program, and the external memory apparatus 14 stores an application program group, an OS (operating system), the printer driver 220, and various other kinds of data. For example, the RAM 13 is used as a working memory according to the various programs stored in the external memory apparatus 14. In this embodiment, the CPU 11 performs processing according to the procedure set forth in the programs stored in the ROM 12, which results in processing according to the functions and flowcharts discussed below being performed by the PC 1. A printing device 2 is connected to the PC 1 via the input/output interface 16. The PC 1 and the printing device 2 are configured separately here, but may instead be configured as a single device.

### Functional Configuration

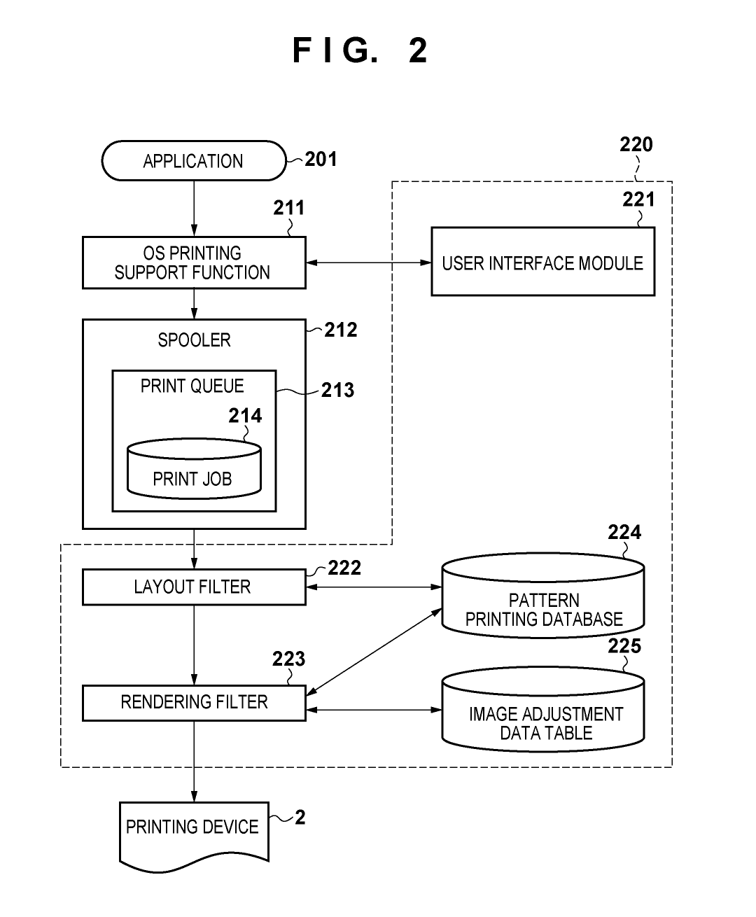

FIG. 2 is a diagram illustrating an example of the functional configuration of an information processing apparatus 1. FIG. 2 mainly illustrates the functions of the printer driver 220 installed in the PC 1. This printing system will now be described using as an example a case in which Microsoft Windows (registered trademark) is used as the OS of the PC 1. Also, XPS (XMLP paper specification), which is an open-source electronic text format developed by Microsoft, will be used as the print job 214. The application 201 includes an image processor, a word processor, a web browser, and other such software. The application 201 edits and treats drawing data composed of image data such as a photograph, graphics data such as a figure, and text data such as letters, according to input from a user. The OS is then requested to print the edited and treated drawing data according to input from the user. Here, the application 201 causes the OS to execute a drawing command group made up of text drawing commands for text data, graphics drawing commands for graphics data, and image drawing commands for image data. The OS converts the various drawing commands issued from the application 201 into XPS data via a printing support function 211. The converted XPS data is temporarily stored in the print queue 213, and managed as the print job 214 by a spooler 212. The print job 214 is converted by the printer driver 220 into a print command that can be interpreted by the printing device 2, after which it is sent to the printing device 2, and printing is performed by the printing device 2.

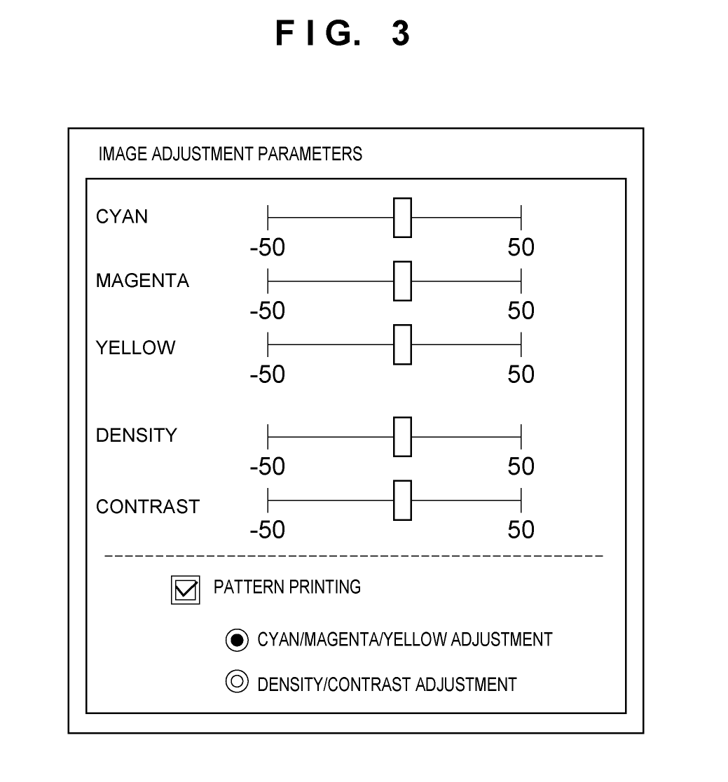

When the user uses an input device to direct the start of printing, the application 201 adds print setting information returned from a user interface module 221, to the print job 214 via the printing support function 211 of the OS. This print setting information includes in the image adjustment parameters, and adjustment values are inputted by the user interface shown in FIG. 3, for example. The print setting information is set ahead of time, before the directive to start printing from the application 201. The print job 214 sent to the printer driver 220 is first processed by a layout filter 222. The term “filter” here means a program (module) having some kind of function of outputting data via processing, such as treatment, conversion, unconversion, or production, based on the inputted data. Filters are called up from a filter management function of the OS (not shown) during despooling of the print job 214, and are initialized. The layout filter 222 subjects the print job 214 to page configuration processing in which the pages of the print job 214 are rearranged according to print setting information, or a plurality of pages are collected into a single page.

A rendering filter 223 rasterizes the print job 214 according to the print setting information. Actually, at this point rasterization is performed by having a rendering engine (not shown) interpret the drawing commands of the print job 214. The rasterized raster image data is multivalued data that holds color as a multistage value, and image adjustment processing (also referred to simply as image processing) is performed on the basis of this. In image processing with the rendering filter, first the hue is adjusted according to cyan, magenta, and yellow adjustment values included in the print setting information. The contrast is then adjusted according to the contrast adjustment values, and finally the density is adjusted according to the density adjustment values. After this, the rendering filter 223 produces halftone data resolved into color components for the inks held in the printing device 2, on the basis of the data that has undergone image processing. An extremely large memory would be needed for this raster main data and halftone data to be processed for an entire page all at once. Thus, the rendering filter 223 can also perform processing (banding processing) in rectangular (band region) units obtained by dividing the printing region on the printing medium into strips, rather than in page units. After this, the rendering filter 223 adds printer commands and so forth, and produces print commands that the printing device 2 can interpret. The rendering filter 223 sends the produced print commands one after the other toward the printing device 2. Once the processing by the printer driver of the front band region is completed during banding processing, that data is sent to the printing device 2, and printing can be commenced.

### Pattern Printing

For a user to adjust a printed image to the desired the color, density, and contrast, adjustment values for adjusting the image quality have to be set with the user interface as shown in FIG. 3. However, simultaneously setting a plurality of image adjustment parameters can be difficult for a user unaccustomed to image processing. In view of this, a plurality of images that are the result of image processing combining image adjustment parameters that vary in stages are printed on a single printing medium so that the user can compare them. The user selects the one that is closest to the desired printed image, and sets the image adjustment parameters for that image to the user interface module during the next printing, which allows the image adjustment parameters to be set with ease.

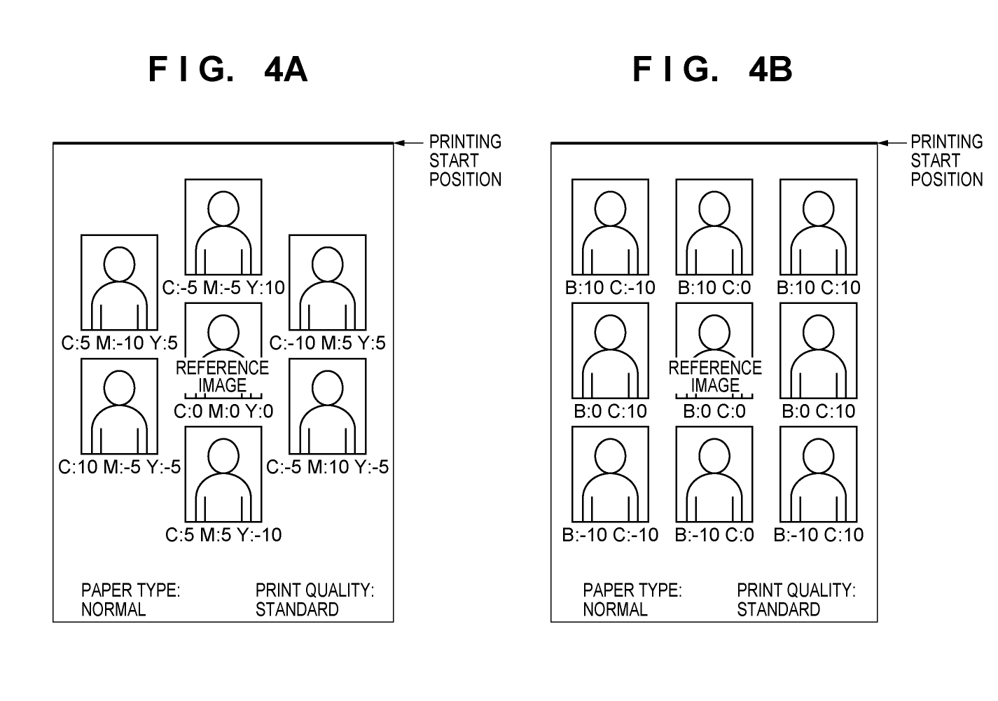

When pattern printing is performed with a printing system such as that shown in FIG. 2, the printing system utilizes a pattern printing database 224 and an image adjustment data table 225. The image adjustment data table will be described in detail in the description related to image processing. The pattern printing database 224 includes the sizes of index images, the coordinates at which the index images are laid out, and image adjustment parameters for the image processing to be performed on the index images. This pattern printing database 224 is constructed at the start of printing on the basis of the print setting information of the user interface module 221 (discussed below). Index numbers are assigned to the index images, starting from 1 and going from the one closest to the printing start position. Also, these index images and corresponding index numbers are stored in the pattern printing database 224. When the index images are laid out in a matrix as in FIG. 4B, since the front row of index images are all the same distance from the printing start position, an index number allocation rule is first established. For instance, when the distance from the printing start position is equal, the index numbers may be allocated from left to right. Hereinafter, an index image with an index number of X shall be denoted as index image X. The layout filter 222 and the rendering filter 223 perform processing by referring to information in the pattern printing database 224.

Next, the flow of processing in the modules of the printer driver 220 will be described for when pattern printing is performed. In this embodiment, a case in which banding processing is performed will be described. First, the user interface module 221 will be described. The user sets information for performing pattern printing as print setting information in the user interface module 221. For example, as shown in the lower part of FIG. 3, the box for performing or not performing pattern printing is checked on the user interface, and the image adjustment parameters to be adjusted are set. The settings here determine the combination of image adjustment parameters to be used in image processing and the layout of the index images. When three parameters are adjusted, such as in adjusting cyan, magenta, and yellow, the index images are laid out in a hexagonal pattern as shown in FIG. 4A. When two parameters are adjusted, such as adjusting the density and contrast, the index images are laid out in a matrix as shown in FIG. 4B. A reduced image that serves as a reference is disposed in the middle. The reference image is subjected to image processing utilizing the image adjustment parameters (reference parameters) inputted on the adjustment bars at the upper part of FIG. 3. The other index images are subjected to image processing using image adjustment parameters that have been varied in stages using these image adjustment parameters as a reference.

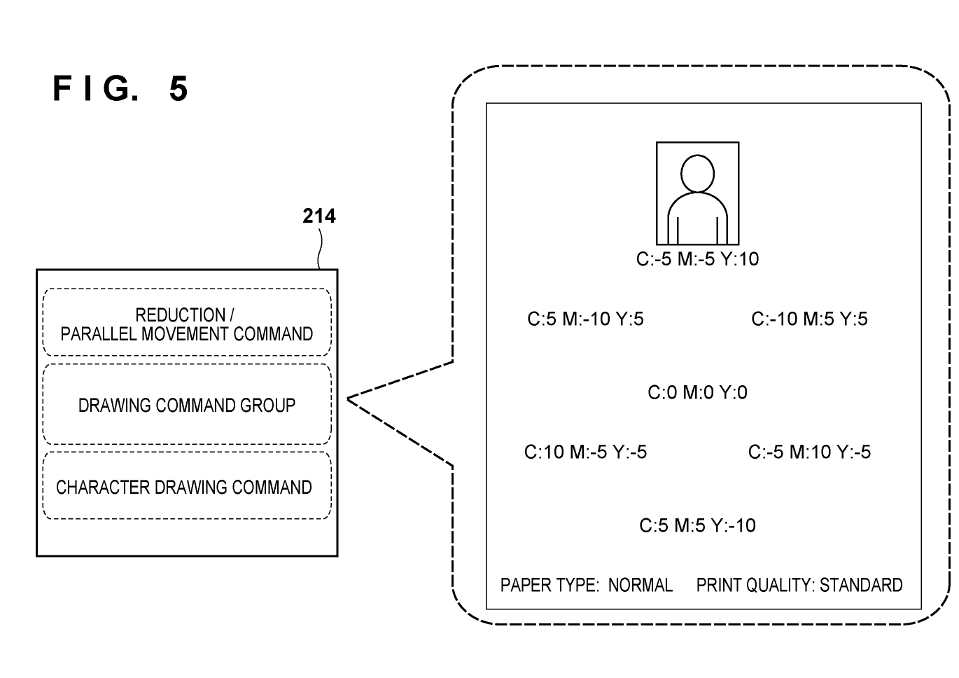

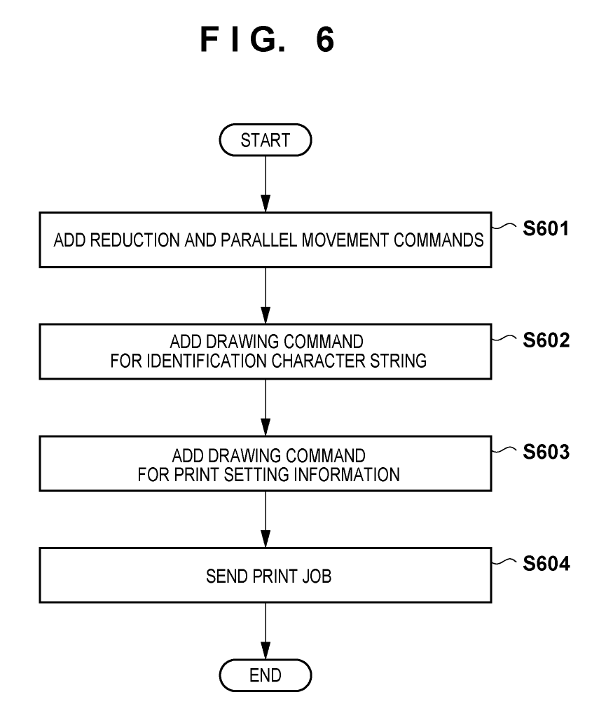

Next, processing done by the layout filter 222 will be described. The layout filter 222 edits XPS data (the print job 214) on the basis of the print setting information, and produces the print job 214 to be used for pattern printing. FIG. 6 is a flowchart of the processing performed by the layout filter 222 when pattern printing has been directed in the printing system. First, the layout filter 222 adds a command for performing reduction and parallel movement to the received print job 214 (S601). The reduction ratio and the amount of parallel movement here are acquired by referring to the pattern printing database 224, and are set so that the original image will be disposed at the position of the index image 1. Next, the layout filter 222 adds a command for drawing a character string (identification character string) for identifying the image adjustment parameters used in image processing performed on the index images (S602). At this point a command for drawing the setting values of the print setting information is also added (S603). Finally, the layout filter 222 sends the edited print job 214 to the rendering filter 223 (S604). As a result of this job production processing, the print job 214 shown in FIG. 5 is sent during cyan, magenta, and yellow adjustment, for example. During normal printing, if a plurality of images are drawn on a single page, the layout filter 222 produces a print job 214 made up of a plurality of pages of drawing commands. Therefore, if a print job 214 is to be produced in which numerous index images are laid out in pattern printing, the drawing command group constituting the print job 214 has to be copied in a quantity equal to the number of index images to be laid out. However, in this embodiment, as shown in FIG. 6, the speed of processing by the layout filter 222 can be increased by omitting this copying by the layout filter 222.

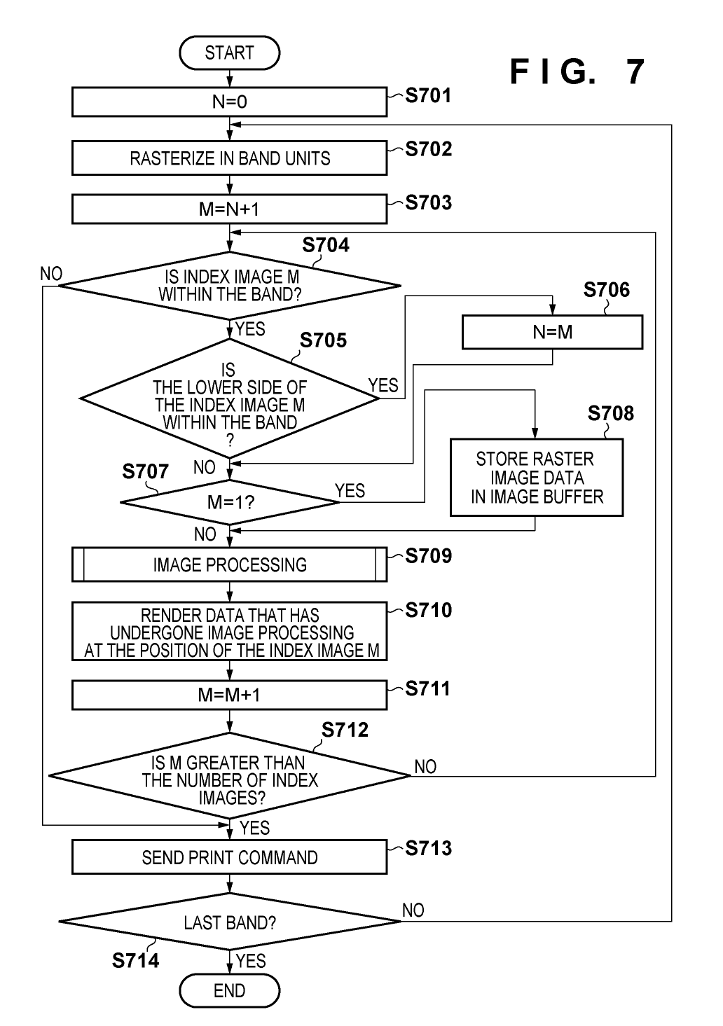

Next, processing with the rendering filter 223 will be described. The rendering filter 223 subjects the print job 214 edited by the layout filter 222 to rasterization image processing, and thereby sends print image data 103 that will become the output result of the pattern printing to the printing device 2. FIG. 7 is a flowchart of the processing performed by the rendering filter 223 when pattern printing has been directed. First, the rendering filter 223 initializes N at 0 (S701). N is the index number of an index image for which processing by the rendering filter has been completed. Next, the rendering filter 223 performs rasterization of the band regions in order, starting from the front band region (S702). The rendering filter 223 then initializes M at N+1 (S703), and determines whether or not the index image M is disposed in the corresponding band region by referring to the pattern printing database 224 (S704). If the answer here is yes, then it is determined whether or not the lower edge position of the index image M is included in the corresponding band region by referring to the pattern printing database 224 (S705). If the answer here is yes, then this means that processing related to the index image M is concluded in the corresponding band region, so N is updated as M (S706). Next, the rendering filter 223 determines whether or not the index image M is the index image 1 (S707). If it is determined to be the index image 1, then raster image data for the region in which the index image 1 is disposed within the corresponding band region (also called merely raster data) is stored in a region set aside in the RAM (image buffer 111) (S708). Consequently, raster image data that has yet to undergo image processing is stored in the image buffer 111.

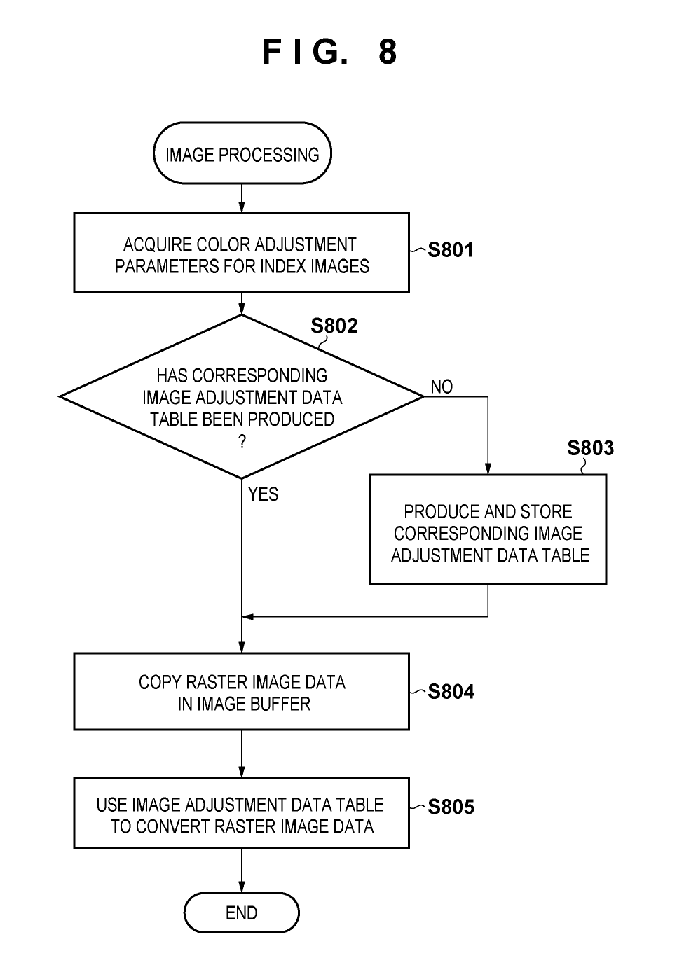

The rendering filter 223 then copies the raster image data in the image buffer 111 and subjects it to image processing (S709). The image processing of S709 will be discussed below through reference to FIG. 8. Next, the rendering filter 223 renders the data that has undergone image processing at the position of the index image M (S710), and updates M as (M+1) (S711). The rendering filter 223 then determines whether or not M is greater than the number of index images on the page (S712), and if it is determined to be less, the flow is repeated from S704. If it is determined in S704 that M is not disposed in the corresponding band region, or if it is determined in S712 that M is greater than the number of index images, then the rendering filter 223 produces a print command on the basis of the raster image data for the corresponding band region. The rendering filter 223 sends the produced print command to the printing device (S713). The rendering filter 223 then determines whether or not the corresponding band region is the last band region on the page (S714), and if the answer here is no, the flow proceeds to S702 and processing is performed on the next band region. If it is determined that the band region is the last one, the rendering filter 223 ends this processing.

In FIG. 7, if the index image 1 is drawn by being divided into a plurality of band regions, in S708 just the raster image data in the region included in the band region currently being processed is stored. If in S710 the index image M is drawn by being divided into a plurality of band regions, then just the raster image data in the region included in the band region currently being processed is copied from the image buffer 111 and rendered.

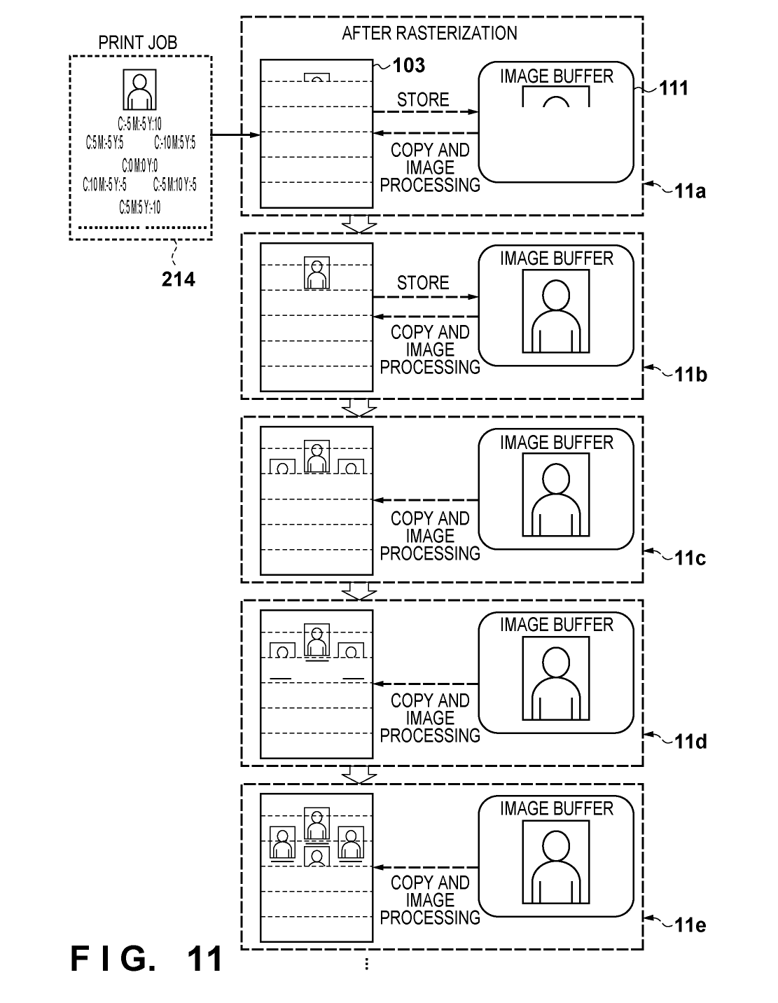

The specific flow of processing of the rendering filter 223 will now be described through reference to FIG. 11. FIG. 11 is a diagram illustrating the process of producing the print image data 103 that is produced by the rendering filter 223 when banding processing is performed. First, the processing related to the front band region will be described. As indicated by processing 11a, since the index image 1 is included in the front band region, rasterized data is stored in the image buffer 111 (S708). The stored raster image data is copied and subjected to image processing, and the resulting data is rendered at the position of the index image 1 (S709, S710). Next, as indicated by processing 11b, the second band region is rasterized, and the data is stored at the position of the index image 1 just as with the front band region. As indicated by processing 11c, for the other index images, the raster image data in the image buffer 111 is copied and subjected to image processing, and the results are rendered at the respective positions. As indicated by processing 11d, in the third band region at first just the character string is rasterized, and then, as indicated by processing lie, the raster image data in the image buffer 111 is rendered at the positions of the respective index images. Thereafter, the raster image data in the image buffer 111 is similarly utilized for all of the index images.

If the layout filter 222 copies drawing commands of the original print job 214 in a quantity equal to the number of index images to be laid out, then rasterization by the rendering filter 223 will end up taking a long time because of the increased number of drawing commands interpreted by the rendering filter 223. With this embodiment, however, as shown in FIG. 7, with the rendering filter 223, the time it takes for rasterization is reduced by only performing rasterization of drawing commands for one image and copying a plurality of sets of raster image data, and this increases the speed of processing with the rendering filter 223.

### Image Processing

In image processing of the index images, since different image adjustment parameters are used for each image, there ends up being a huge number of calculations for calculating the adjusted values. In such a case, the adjusted values are generally calculated ahead of time, and their correspondence with unadjusted values is stored in the form of a data table. In this embodiment, this data table is called the image adjustment data table 225. When the above method is employed in pattern printing, the image adjustment data table 225 has to be different for each index image. For example, the timing at which the image adjustment data table 225 is produced may be during initialization of the rendering filter 223. However, if all of the image adjustment data tables 225 required for pattern printing are produced during initialization of the rendering filter 223, the rendering filter 223 cannot perform any other processing, such as rasterization, until the production of these is finished. Accordingly, the print job 214 that would ordinarily be processed right away goes into a standby state, and it takes a long time for printing to start. For example, when banding processing is performed, the rendering filter 223 can start processing as long as the image adjustment data tables 225 required for the image processing of the index images included in the corresponding band region have been produced. However, if all of the image adjustment data tables 225 required for pattern printing are produced, the user will have to wait until the production of all of these image adjustment data tables 225 is finished. In view of this, in this embodiment only the image adjustment data tables 225 are produced which are required when the rendering filter 223 performs image processing on raster image data.

FIG. 8 is a flowchart of the image processing performed by the rendering filter 223 when pattern printing has been directed in a printing system. First, the rendering filter 223 refers to the pattern printing database 224 and acquires image adjustment parameters for the index images being processed from the print setting information (S801). Next, the rendering filter 223 determines whether or not the image adjustment data table 225 corresponding to the acquired image adjustment parameters has been produced (S802). If it has not been produced, a new one is produced and storage in a searchable form in the RAM (S803). The rendering filter 223 then copies the raster image data in the image buffer 111 (S804), and uses the image adjustment data table 225 to convert the copied raster image data (S805).

As a result of the above processing, unnecessary data table production time can be curtailed, and printing can commence sooner, even when performing banding processing. In the description of the above embodiment, processing is allocated and executed between the layout filter 222 and the rendering filter, but the processing performed by these may instead be executed by a single filter. Also, XPS is used as the print job 214 in this example, but EMF may be used instead. For example, with a GDI driver in which the print job 214 is EMF, the processing performed by the layout filter 222 may be performed by a print processor, and the processing performed by the rendering filter 223 may be performed by a graphics driver.

### Embodiment 2

This embodiment can be applied when banding processing is not performed by a printer driver. This example differs from embodiment 1 in part of the processing by the layout filter 222 shown in FIG. 6 and in part of the processing by the rendering filter 223 shown in FIG. 7. In this embodiment, the position where the original image is disposed is not limited to the position of the index image 1 when the layout filter 222 adds a command for reduction and parallel movement to the received print job 214. Specifically, the pattern printing database 224 stores the coordinates at which the original image is disposed, apart from the coordinates of the index images. In S601, when the layout filter 222 adds reduction and parallel movement commands, the reduction ratio and the amount of parallel movement are set so that the original image will be disposed at that position. However, this position has to be one that does not overlap the drawing of identification character strings or the like. The rest of the processing by the layout filter 222 is the same as the processing shown in FIG. 6.

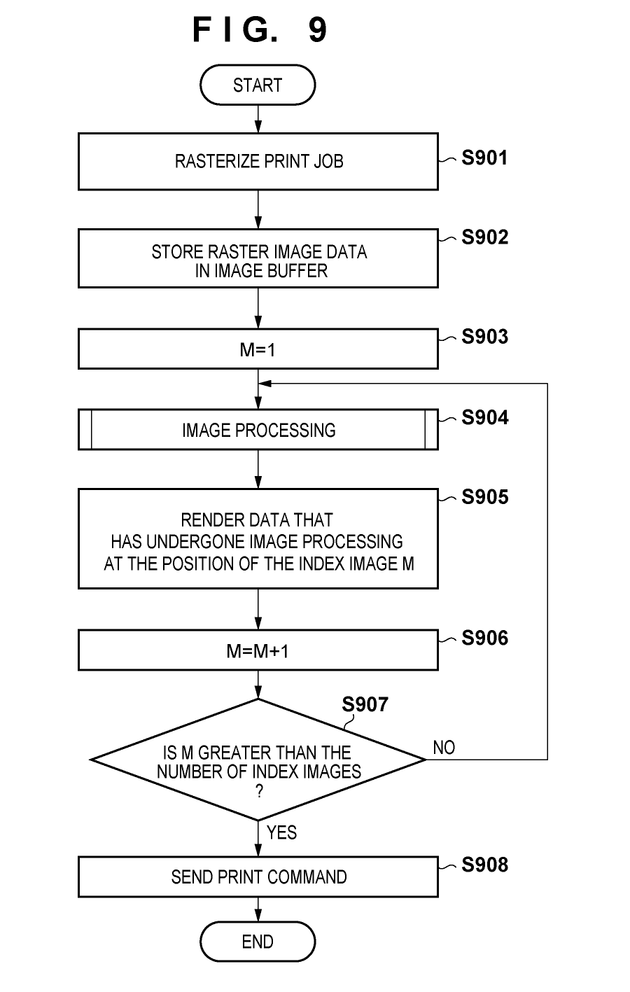

FIG. 9 shows the processing by the rendering filter 223 in this embodiment. First, the rendering filter 223 rasterizes the received print job 214 (S901). Then, the rendering filter 223 refers to the pattern printing database 224 and stores the original image disposed at the above-mentioned coordinates in the image buffer 111 (S902). M is then initialized at 1 (S903), and image processing corresponding to the index image M is performed (S904). The processing from S905 to S908 is the same as the processing in S710 to S713 described in embodiment 1.

### Embodiment 3

In this embodiment, a page for drawing according to identification character strings and print setting information is produced apart from other pages. This example differs from embodiments 1 and 2 in part of the processing by the layout filter 222 shown in FIG. 6 and in part of the processing by the rendering filter 223 shown in FIGS. 7 and 9. The processing by the layout filter 222 in this example is as follows. First, the processing of S601 is performed, and at this point the layout filter 222 acquires from the pattern printing database 224 the coordinates at which the original image is disposed and determines the reduction ratio and the amount of parallel movement, just as in embodiment 2. However, in this example, the limitation of disposing the original image at a position that does not overlap the drawing position of identification character strings and so forth is not imposed as in embodiment 2. Next, the layout filter 222 produces a new print page. The original print page here is page 1, and the newly produced page is included in the print job 214 as page 2. The layout filter 222 then subjects the print page of page 2 to the processing of S602 and S603. Finally, the layout filter 222 executes the processing of S604. At this point, the layout filter 222 sends the rendering filter 223 two pages of the print job 214, which includes the newly produced page.

The rendering filter 223 refers to the pattern printing database 224 for the print page of page 1, and stores the original image disposed at the above-mentioned coordinates in the image buffer 111. Print processing is ended without sending the print page of page 1 to the subsequent module. The processing of the print page of page 2 will now be described. Since the original image is stored in the processing of page 1, in the processing of page 2, processing is executed in which the portion involving storage of the original image is eliminated from the processing by the rendering filter 223 shown in FIGS. 7 and 9. First, if banding processing is performed by the printer driver, then processing that excludes the processing of S707 and S708 is performed in the processing by the rendering filter 223 shown in FIG. 7. If banding processing is not performed by the printer driver, then processing that excludes the processing of S702 is performed in the processing by the rendering filter 223 shown in FIG. 7.

### Embodiment 4

In embodiment 1, as shown in FIG. 3, image adjustment was performed which involved the adjustment of cyan, magenta, yellow, density, and contrast as shown in FIG. 3. In contrast, in this embodiment, correction treatment processing involving “face sharpness correction” is performed. Correction treatment processing involving the correction of the clarity of an image, called “face sharpness correction,” can be such that the determination threshold in region determination, in which it is determined what correction treatment processing will be added to, is varied in ten stages, and the products thereof are produced as index images. In this case, thresholds for different region determinations are used as image adjustment parameters for each of the index images. As to setting these thresholds, they can be derived, for example, by using general facial region determination and varying the determination threshold in stages. Alternatively, rather than varying the determination threshold, a plurality of mutually different (a maximum of ten) determinations can be processes, and these can be used as image adjustment parameters.

Just as in FIG. 8 of embodiment 1, first the rendering filter 223 refers to the pattern printing database 224 and acquires image adjustment parameters for the index images being processed from the print setting information (S801). Next, the rendering filter 223 determines whether or not the image adjustment data table 225 corresponding to the acquired image adjustment parameters has been produced (S802). If it has not been produced, a new one is produced and storage in a searchable form in the RAM (S803). The rendering filter 223 then copies the raster image data in the image buffer 111 (S804), and uses the image adjustment data table 225 to convert the copied raster image data (S805). The rest of the processing is the same as in embodiment 1.

An aspect was given here of application of correction treatment processing called “face sharpness correction,” but correction treatment on red-eye correction or the brightness adjustment value can also be set as region determination processing, and the determination thresholds for these can be calculated and applied to execution of pattern printing. Also, it is possible for the index images to be produced by varying the correction strength in ten stages for correction treatment processing of “face sharpness correction,” red-eye correction, or the like. In this case, different image adjustment parameters are used for each of the index images. As to the setting of the image adjustment parameters, general correction treatment processing may be used and the settings may be derived by varying a correction coefficient in stages.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-055222, filed Mar. 14, 2011, which is hereby incorporated by reference herein in its entirety.

What is claimed is:

1. An information processing apparatus, comprising:
an acquisition unit configured to acquire image data;
an accept unit configured to accept a reference parameter that sets a reference image quality;
a parameter generation unit configured to generate a predetermined quantity of parameter values that are varied in stages, on the basis of the reference parameter;
a job generation unit configured to generate a print job including a drawing command for printing a reduced image of the image data;
a conversion unit configured to convert the drawing command included in the print job into raster data;
a storage unit configured to store the raster data converted by the conversion unit;
a copying unit configured to copy a predetermined quantity of the raster data stored by the storage unit;
a first processing unit configured to subject the raster data copied by the copying unit to image adjustment processing on the basis of the reference parameter; and
a second processing unit configured to subject the raster data copied by the copying unit to the image adjustment processing on the basis of the parameter values generated by the parameter generation unit.

2. The information processing apparatus according to claim 1, further comprising a printing unit configured to print, on a single printing medium, the reduced images for the raster data processed by the first and second processing units, so that the user can compare the images.

3. The information processing apparatus according to claim 1,
wherein the conversion unit converts the drawing command included in the print job into raster data for each band region obtained by dividing up printing region on the printing medium, and
the drawing command is for printing a reduced image of the image data within the front band region in the printing region on the printing medium.

4. The information processing apparatus according to claim 1, wherein the reference parameter for adjusting the image quality is for adjusting contrast, density, and color, including cyan, magenta, and yellow.

5. The information processing apparatus according to claim 1, wherein the reference parameter for adjusting the image quality is for adjusting the sharpness expressed by the image data.

6. An information processing method executed by an information processing apparatus, comprising:
an acquisition step of acquiring image data;
an accept step of accepting a reference parameter that sets a reference image quality;
a parameter generation step of generating a predetermined quantity of parameter values that are varied in stages, on the basis of the reference parameter;
a job generation step of generating a print job including a drawing command for printing a reduced image of the image data;
a conversion step of converting the drawing command included in the print job into raster data;
a storage step of storing the raster data converted by the conversion step;
a copying step of copying a predetermined quantity of the raster data stored by the storage step;
a first processing step of subjecting the raster data copied by the copying step to image adjustment processing on the basis of the reference parameter; and
a second processing step of subjecting the raster data copied by the copying step to the image adjustment processing on the basis of the parameter values generated by the parameter generation step.

7. A recording medium that can be read by a computer and that stores a program that causes the computer to execute the steps of:
an acquisition step of acquiring image data;
an accept step of accepting a reference parameter that sets a reference image quality;
a parameter generation step of generating a predetermined quantity of parameter values that are varied in stages, on the basis of the reference parameter;
a job generation step of generating a print job including a drawing command for printing a reduced image of the image data;
a conversion step of converting the drawing command included in the print job into raster data;
a storage step of storing the raster data converted by the conversion step;
a copying step of copying a predetermined quantity of the raster data stored by the storage step;
a first processing step of subjecting the raster data copied by the copying step to image adjustment processing on the basis of the reference parameter; and
a second processing step of subjecting the raster data copied by the copying step to the image adjustment processing on the basis of the parameter values generated by the parameter generation step.
